(19) United States
(12) Patent Application Publication
(10) Pub. No.: US 2015/0373409 A1
(43) Pub. Date: Dec. 24, 2015

(54) METHOD AND SYSTEM FOR IDENTIFYING AN AUDIENCE, AND A MOBILE DEVICE

(71) Applicants: Hung-Yuan LIN, Taipei City (TW); AGTOP TECHNOLOGY CORP., Taipei City (TW)

(72) Inventor: Hung-Yuan LIN, Taipei City (TW)

(21) Appl. No.: 14/741,338

(22) Filed: Jun. 16, 2015

(30) Foreign Application Priority Data
Jun. 20, 2014 (TW) 103210920
Dec. 18, 2014 (TW) 103144324

(51) Int. Cl. H04N 21/45; H04N 21/258; H04W 4/00

(52) U.S. Cl. CPC H04N 21/4532; H04W 4/008; H04N 21/25808

(57) ABSTRACT

A method for identifying an audience includes receiving, by an identification server, a device identifier corresponding exclusively to an AV device, in combination with personal identity information of the audience transmitted by a mobile device that is possessed by the audience, and comparing, by the identification server, the device identifier thus received with the device identifier stored in the identification server so as to ascertain the AV device corresponding to the device identifier thus received, and so as to determine the identity of the audience who is nearby the AV device based on the personal identity information.

### CROSS-REFERENCE TO RELATED APPLICATION

This application claims priorities of Taiwanese Patent Applications No. 103210920, filed on Jun. 20, 2014, and No. 103144324, filed on Dec. 18, 2014.

### FIELD

The disclosure relates to a method, a system and a mobile device for identifying an audience, more particularly to a method, a system and a mobile device for determining an identity of an audience who is nearby an audio/video (AV) device.

### BACKGROUND

Knowledge of the number of audience of a television program broadcasted on a traditional media device, such as a television, is always desirable for a media content provider, such as a producer of the television program. The number of audience measured may serve as a basis for improvement of media content and for seeking more advertisement opportunities. Therefore, the conventional audience measurement is practiced to satisfy the aforementioned needs for audience information.

However, the conventional audience measurement relies on a dedicated set-top box which is connected to a television to detect whether the television is turned on and which channel the television is tuned to, so as to estimate a television rating point of a certain media content. However, the approach to estimate a television rating point has some drawbacks, one of which is that the set-top box cannot obtain identity information of the audience, such as information associated with gender, age, etc. Therefore, the television rating point cannot substantially reflect the identity of an audience, and the broadcasted media content and advertisement may not be adjusted correspondingly for different audiences.

### SUMMARY

Therefore, an object of the disclosure is to provide a method and a system for identifying an audience, as well as a mobile device to determine an identity of an audience nearby an audio/video (AV) device.

In a first aspect of the disclosure, the method for identifying an audience is configured to determine an identity of an audience nearby an AV device. The audience possesses a mobile device which stores personal identity information of the audience and which obtains in advance a device identifier corresponding exclusively to the AV device when nearby the AV device. The mobile device is communicable with an identification server which stores the device identifier. The method includes the steps of:

receiving, by the identification server, the device identifier in combination with the personal identity information transmitted by the mobile device; and

comparing, by the identification server, the device identifier thus received with the device identifier stored in the identification server so as to ascertain the AV device corresponding to the device identifier thus received, and so as to determine the identity of the audience who is nearby the AV device based on the personal identity information.

In a second aspect of the disclosure, the system for identifying an audience is configured to determine an identity of an audience nearby an AV device. The system includes an AV device, a mobile device and an identification server. The mobile device is possessed by the audience, stores personal identity information of the audience, and obtains in advance a device identifier corresponding exclusively to the AV device. The identification server is communicable with the mobile device, stores the device identifier, and is configured to

receive the device identifier in combination with the personal identity information transmitted by the mobile device, and

compare the device identifier thus received with the device identifier stored in the identification server so as to ascertain the AV device corresponding to the device identifier thus received, and so as to determine the identity of the audience who is nearby the AV device based on the personal identity information.

In a third aspect of the disclosure, the mobile device is wirelessly communicable with an AV device and an identification server. The identification server stores a device identifier that corresponds exclusively to the AV device. The AV device stores the device identifier, includes a first short-range wireless communication unit, and periodically transmits the device identifier through the first short-range wireless communication unit. The mobile includes a processor unit, a memory unit, a wireless network interface and a second short-range wireless communication unit. The memory unit is coupled to the processor unit and stores personal identity information of an audience who possesses the mobile device. The wireless network inter race is coupled to the processor unit. The second short-range wireless communication unit is coupled to the processor unit, receives the device identifier transmitted by the AV device when the mobile device is brought within a transmission range of the first short-range wireless communication unit of the AV device, and provides the device identifier thus received to the processor unit. The processor unit transmits, through one of the wireless network interface and the second short-range wireless communication unit, the device identifier in combination with the personal identify information stored in the memory unit to the identification server. The device identifier in combination with the personal identity information enables the identification server to determine an identity of the audience who is nearby the AV device based on the device identifier and the personal identity information.

An effect of the disclosure resides in that, by virtue of the mobile device which receives the device identifier transmitted by the device through the short-range wireless communication technology, and which transmits the device identifier in combination with the personal identity information of the audience who possesses the mobile device to the identification server, the identification server is enabled to determine the identity of the audience nearby the AV device based on the device identifier of the AV device and the personal identity information, so as to facilitate more accurate audience measurement and relevant applications.

### BRIEF DESCRIPTION OF THE DRAWINGS

Other features and advantages of the disclosure will become apparent in the following detailed description of the embodiments with reference to the accompanying drawings, of which:

FIG. 1 is a flow chart of an embodiment of a method for identifying an audience according to the disclosures and

FIG. 2 is a block diagram of an embodiment of a system for identifying an audience according to the disclosure.

### DETAILED DESCRIPTION

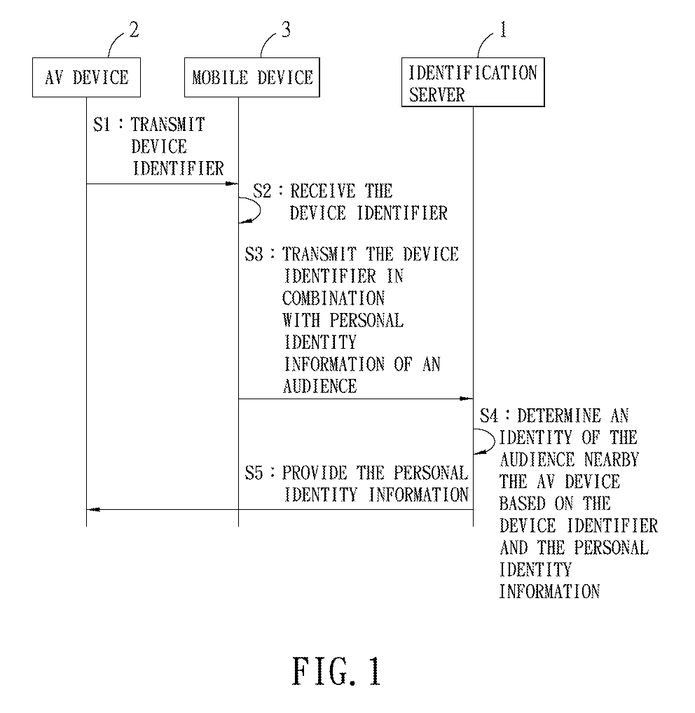

Referring to FIG. 1, a flow chart of an embodiment of a method for identifying an audience according to the disclosure is illustrated. The method is to be implemented by an identification server 1, an audio/video (AV) device 2 and a mobile device 3 to determine an identity of an audience nearby the AV device 2. The AV device 2 stores therein a device identifier corresponding exclusively to the AV device 2. The audience possesses the mobile device 3 which stores personal identify information of the audience. Therefore, the identification server 1, the AV device 2 and the mobile device 3 together constitute an embodiment of a system for identifying an audience according to the disclosure.

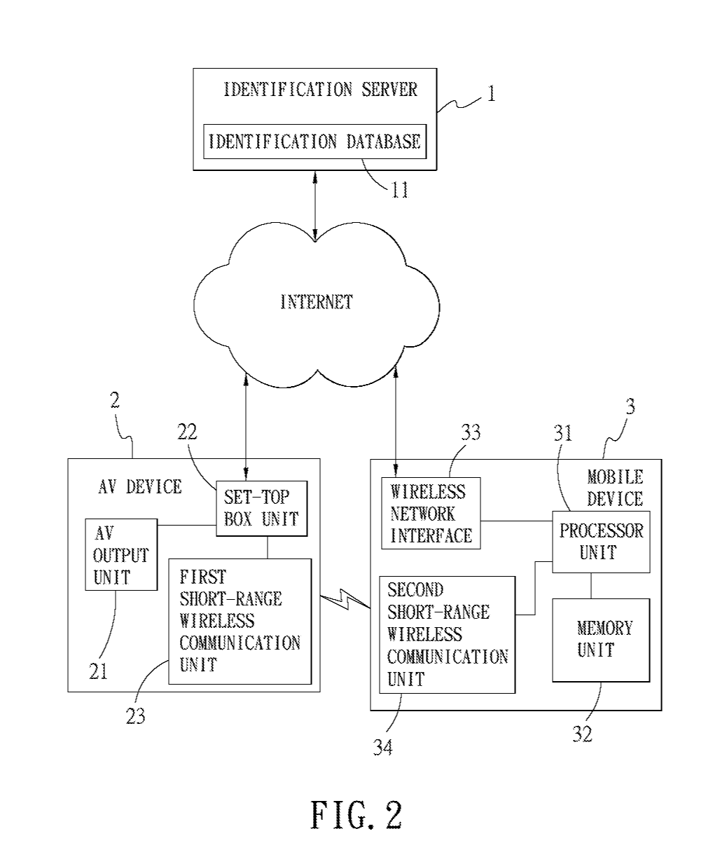

Specifically, referring to FIG. 2, the identification server 1 of this embodiment is a mainframe computer, and includes an identification database 11 which stores the device identifier of the AV device 2. In an environment that a plurality of AV devices are operating, the identification database 11 stores a plurality of distinct device identifiers corresponding respectively to the AV devices.

The AV device 2 includes an AV output unit 21, a set-top box unit 22 connected electrically to the AV output unit 21, and a first short-range wireless communication unit 23 connected electrically to the set-top box unit 22. In this embodiment, the AV output unit 21 is a television, the set-top box unit 22 is used to receive digital television signals for subsequent playback by the AV output unit 21. Moreover, the set-top box unit 22 is connected to the identification server 1 through the Internet. The first short-range wireless communication unit 23 is configured to store the device identifier of the AV device 2, and is configured to periodically broadcast the device identifier stored therein within a 10-meter radius, approximately. In this embodiment, the first short-range wireless communication unit 23 is an iBeacon base station which utilizes the iBeacon protocol standardized by Apple Inc., and which transmits and receives Bluetooth wireless signals. Alternatively, the first short-range wireless communication unit 23 may be at least an iBeacon Bluetooth transmitter which transmits Bluetooth wireless signals, and practical implementation of the same should not be limited herein.

Furthermore, the AV output unit 21, the set-top box unit 22 and the first short-range wireless communication unit 23 may also be integrated to serve as a smart television. It is noted that, the identification server 1 may also be integrated into the set-top box unit 22 of the AV device 2, and is not limited to being a stand-alone mainframe computer.

The mobile device 3 is a personal electronic device, such as a smart phone, an iPad or a tablet computer. In this embodiment, the mobile device 3 includes a processor unit 31, a memory unit 32, a wireless network interface 33 and a second short-range wireless communication unit 34. The memory unit 32 stores the personal identity information of the audience who possesses the mobile device 3, for example, a telephone number, gender, age, and other personal information. The wireless network interface 33 is connected to the identification server 1 through the Internet. The second short-range wireless communication unit 34 in this embodiment is an iBeacon Bluetooth receiver capable of receiving Bluetooth wireless signals. Alternatively, the second short-range wireless communication unit 34 may be an iBeacon base station capable of transmitting and receiving Bluetooth wireless signals, and should not be limited to the disclosure herein. That is to say, the second short-range wireless communication unit 34 may be any unit capable of conducting short-range wireless communication with the first short-range wireless communication unit 23.

Referring once again to FIG. 1, the embodiment of the method for identifying an audience according to the disclosure includes the following steps.

In step S1, when the AV device 2 is in an activated state, the AV device 2 is configured to periodically transmit (i.e., broadcast), through the first short-range wireless communication unit 23, the device identifier stored in the AV device 2. In this way, when the audience carrying the mobile device 3 is nearby the AV device 2, and moves within a broadcast range (of for example, 10 meters) of the first short-range wireless communication unit 23, step 32 is performed.

In step S2, the second short-range wireless communication unit 34 of the mobile device 3 is configured to receive the device identifier broadcasted by the first short-range wireless communication unit 23, and to provide the device identifier thus received to the processor unit 31. Subsequently, the processor unit 31 retrieves the personal identity information of the audience from the memory unit 32, and the flow proceeds to step S3.

In step S3, the processor unit 31 is configured to transmit, through the wireless network interface 33, the device identifier in combination with the personal identity information to the identification server 1.

In step S4, after receiving the device identifier in combination with the personal identity information transmitted by the mobile device 3, the identification server 1 is configured to compare the device identifier thus received with the device identifier stored in the identification database 11 so as to ascertain the AV device 2 corresponding to the device identifier thus received, and so as to determine the identify of the audience who is nearby the AV device 2 based on the personal identity information. In this way, if the identification server 1 is informed of media content which the AV device 2 is currently playing, the identification server 1 is able to further determine that the audience might be watching the media content currently being played on the AV device 2. In addition, the identification server 1 is further configured to store the device identifier in combination with the personal identity information thus received into the identification database 11.

Moreover, the identification server 1 is further configured to obtain personal information of the audience from the personal identity information received in step S4, so as to facilitate more accurate rating audience measurement and to realize relevant applications based on the audience measurement. For example, to adjust media content or advertisement content, or to adjust the time on which the media content and the advertisement are broadcasted, the effectiveness of the advertisement and the television rating point of the media content might be promoted.

In step S5, the identification server 1 is further configured to provide the personal identity information received from the mobile device 3 to the AV device 2, for subsequent application by the AV device 2. For example, information such as which media content, television program or advertisement is being played at the time (and might foe watched by the audience), and which time of day the audience is (possibly) watching the AV device 2 may be recorded by the AV device 2.

Moreover, in another embodiment of the system for identifying an audience according to the disclosure, the identification server 1 is integrated into the AV device 2. The mobile device 3 is configured to transmit, through the second short-range wireless communication unit 34, the device identifier in combination with the personal identity information to the AV device 2 integrated with the identification server 1. The AV device 2 integrated with the identification server 1 is configured to receive, through the first short-range wireless communication unit 23, the device identifier in combination with the personal identity information transmitted by the mobile device 3.

To sum up, by virtue of the mobile device 3 which receives the device identifier transmitted by the AV device 2 through the short-range wireless communication technology, and which transmits the device identifier in combination with the personal identity information of the audience who possesses the mobile device 3 to the identification server 1, the identification server 1 is enabled to determine the identity of the audience nearby the AV device 2 based on the personal identify information and to associate the audience with a currently played media content/advertisement on the AV device 2 based on the device identifier of the AV device 2, so as to facilitate more accurate audience measurement and more effective applications.

While the disclosure has been described, in connection with what is(are) considered the exemplary embodiment(s), it is understood that this disclosure is not limited to the disclosed embodiment(s) but is intended to cover various arrangements included within the spirit and scope of the broadest interpretation so as to encompass ail such modifications and equivalent arrangements.

What is claimed is:

1. A method for identifying an audience being configured to determine an identity of an audience nearby an audio/video (AV) device, the audience possessing a mobile device which stores personal identity information of the audience and which obtains in advance a device identifier corresponding exclusively to the AV device when nearby the AV device, the mobile device being communicable with an identification server which stores the device identifier, the method comprising the steps of;
receiving, by the identification server, the device identifier in combination with the personal identity information transmitted by the mobile device; and
comparing, by the identification server, the device identifier thus received with the device identifier stored in the identification server so as to ascertain the AV device corresponding to the device identifier thus received, and so as to determine the identity of the audience who is nearby the AV device based on the personal identify information.

2. The method of claim 1, the AV device storing the device identifier and including a first short-range wireless communication unit, the mobile device including a second short-range wireless communication unit, the method, prior to the step of receiving the device identifier in combination with the personal identity information, further comprising the steps of;
receiving, by the mobile device through the second short-range wireless communication unit, the device identifier transmitted by the AV device through the first short-range wireless communication unit when the mobile device is brought within a transmission range of the first short-range wireless communication unit of the AV device; and
transmitting, by the mobile device, the device identifier thus received in combination with the personal identity information stored in the mobile device to the identification server.

3. The method of claim 2, prior to the step of receiving the device identifier transmitted by the AV device, further comprising the step of:
periodically transmitting, by the AV device through the first short-range wireless communication unit, the device identifier stored in the AV device.

4. The method of claim 2, the identification server being integrated into the AV device, wherein:
the step of transmitting the device identifier thus received in combination with the personal identity information includes transmitting, by the mobile device through the second short-range wireless communication unit, the device identifier thus received in combination with the personal identity information stored in the mobile device to the AV device integrated with the identification server; and
the step of receiving the device identifier in combination with the personal identity information includes receiving, by the AV device integrated with the identification server through the first short-range wireless communication unit, the device identifier in combination with the personal identity information transmitted by the mobile device.

5. The method of claim 2, subsequent to the step of comparing the device identifier thus received with the device identifier stored in the identification server, further comprising the step of:
providing, by the identification server, the personal identity information received from the mobile device to the AV device.

6. The method of claim 5, the AV device further including a set-top box unit which is coupled electrically to the first short-range wireless communication unit and which is connected to the identification server, the method, subsequent to the step of providing the personal identity information, further comprising the step of:
obtaining, by the AV device through the set-top box unit, the personal identity information provided by the identification server.

7. The method of claim 1, the identification server including an identification database, the method, subsequent to the step of receiving the device identifier in combination with the personal identity information, further comprising:
storing, by the identification server, the device identifier in combination with the personal identity information into the identification database.

8. A system for identifying an audience being configured to determine an identity of an audience nearby an audio/video (AV) device, said system comprising:
an AV device;
a mobile device which is possessed by the audience, which stores personal identity information of the audience, and which obtains in advance a device identifier corresponding exclusively to said AV device when nearby said AV device; and
an identification server which is communicable with said mobile device, which stores the device identifier, and which is configured to
receive the device identifier in combination with the personal identity information transmitted by said mobile device, and
compare the device identifier thus received with the device identifier stored in the identification server so as to ascertain the AV device corresponding to the device identifier thus received, and so as to determine the identity of the audience who is nearby the AV device based on the personal identity information.

9. The system of claim 8, wherein:
said AV device stores the device identifier and includes a first short-range wireless communication unit; and
said mobile device includes a second short-range wireless communication unit, and is configured to
receive, through said second short-range wireless communication unit, the device identifier transmitted by said AV device through said first short-range wireless communication unit when said mobile device is brought with a transmission range of said first short-range wireless communication unit of said AV device, and
transmit the device identifier thus received in combination with the personal identity information stored in said mobile device to said identification server.

10. The system of claim 9, wherein said AV device is configured to periodically transmit, through said first short-range wireless communication unit, the device identifier stored in said AV device.

11. The system of claim 9, wherein:
said identification server is integrated into said AV device;
said mobile device is configured to transmit, through said second short-range wireless communication unit, the device identifier thus received in combination with the personal identity information stored in said mobile device to said AV device integrated with said identification server; and
said AV device integrated with said identification server is configured to receive, through said first short-range wireless communication unit, the device identifier in combination with the personal identity information transmitted by said mobile device.

12. The system of claim 9, wherein said identification server is configured to provide the personal identity information received from said mobile device to said AV device.

13. The system of claim 12, wherein said AV device further includes a set-top box unit which is coupled electrically to said first short-range wireless communication unit and which is connected to said identification server, said AV device being configured to obtain, through the set-top box unit, the personal identity information provided by said identification server.

14. The system of claim 8, wherein said identification server includes an identification database, and is configured to store the device identifier in combination with the personal identity information into said identification database.

15. A mobile device wirelessly communicable with an audio/video (AV) device and an identification server, the identification server storing a device identifier that corresponds exclusively to the AV device, the AV device storing the device identifier, including a first short-range wireless communication unit, and periodically transmitting the device identifier through the first short-range wireless communication unit, said mobile comprising:
a processor unit;
a memory unit which is coupled to said processor unit and which stores personal identity information of an audience who possesses said mobile device;
a wireless network interface which is coupled to said processor unit; and
a second short-range wireless communication unit which is coupled to said processor unit, which receives the device identifier transmitted by the AV device when said mobile device is brought within a transmission range of the first short-range wireless communication unit of the AV device, and which provides the device identifier thus received to said processor unit;
wherein said processor unit transmits, through one of said wireless network interface and said second short-range wireless communication unit, the device identifier in combination with the personal identity information stored in said memory unit to the identification server, the device identifier in combination with the personal identity information enabling said identification server to determine an identity of the audience who is nearby the AV device based on the device identifier and the personal identity information.

16. The mobile device of claim 15, the identification server being integrated into the AV device, wherein
said processor unit transmits, through said second short-range wireless communication unit, the device identifier in combination with the personal identity information stored in said memory unit to the AV device integrated with the identification server, the AV device integrated with the identification server receiving, through the first short-range wireless communication unit, the device identifier in combination with the personal identity information transmitted by said mobile device.
